(19) United States
(12) Patent Application Publication
(10) Pub. No.: US 2025/0197135 A1
(43) Pub. Date: Jun. 19, 2025

(54) CONVEYANCE DEVICE

(71) Applicant: Toyo Tire Corporation, Itami-shi (JP)

(72) Inventors: Kazuma Hanafusa, Itami-shi (JP); Yoshito Nishiguchi, Itami-shi (JP)

(73) Assignee: Toyo Tire Corporation, Itami-shi (JP)

(21) Appl. No.: 18/943,021

(22) Filed: Nov. 11, 2024

(30) Foreign Application Priority Data
Dec. 13, 2023 (JP) 2023-209788

(51) Int. Cl. B65G 47/91; B29D 30/00

(52) U.S. Cl. CPC B65G 47/912; B29D 30/0016; B29D 2030/0038; B65G 2201/0273; B65G 2207/08

(57) ABSTRACT

Provided is a conveyance device allowing simple management of a replacement component while an increase in the number of set-up change steps due to a tire size change is suppressed. The conveyance device includes an annular frame capable of surrounding the outer peripheries of a first drum and a second drum, and a sucker provided for the annular frame. The sucker includes a plurality of suction pads that sucks a tire forming member and a plurality of movement mechanisms that moves the suction pads in the radial direction of the annular frame. The plurality of suction pads is provided side by side in the circumferential direction of the annular frame, and adjacent ones of the suction pads in the circumferential direction are moved in the radial direction by different ones of the movement mechanisms.

### BACKGROUND OF THE INVENTION

### 1. Field of the Invention

The present invention relates to a conveyance device.

### 2. Description of Related Art

There has been known a method of preparing tire forming members in parallel using a plurality of drums and a conveyance device with this process divided in a tire molding apparatus used for manufacturing pneumatic tires.

For example, there is a method of performing, at separate stages, a step of molding a cylindrical band member including an inner liner and a carcass on a band drum, a step of molding a cylindrical belt member including a belt on a belt drum, and a step of integrally molding (shaping) the band member and the belt member into a tire shape and transferring (i.e., delivering) a tire forming member between the steps using a conveyance device.

As such a conveyance device, for example, there has been known a conveyance device including a suction pad that sucks, from the outer diameter side, a cylindrical tire forming member wound around the outer periphery of a drum, a movement mechanism that moves the suction pad in the radial direction of the drum, a unit that causes the suction pad to contact and separate from the drum, and a unit that transfers the suction pad sucking the tire forming member to a next step (see, e.g., JP2001-138404A (Patent Literature 1)).

However, in the conveyance device of Patent Literature 1 above, a vacuum chamber to which a plurality of suction pads adjacent to each other in the circumferential direction is attached is moved in the radial direction by one movement mechanism. In order to manufacture tires with different sizes using this conveyance device, the vacuum chamber to which the suction pads are attached needs to be prepared for each tire size, and the vacuum chamber of the conveyance device needs to be replaced in every size change. For this reason, the number of set-up change steps increases due to a tire size change, and management of a replacement component is complicated.

### SUMMARY OF THE INVENTION

The present invention has been made in view of the above-described situation, and an object thereof is to propose a conveyance device allowing simple management of a replacement component while an increase in the number of set-up change steps due to a tire size change is suppressed.

The present invention includes embodiments below.

[1] A conveyance device for receiving a cylindrical tire forming member formed on a first drum from the first drum and conveying the tire forming member to a second drum includes an annular frame capable of surrounding the outer peripheries of the first drum and the second drum, a sucker provided for the annular frame, and a frame conveyer that conveys the annular frame between the first drum and the second drum. The sucker includes a plurality of suction pads that sucks the tire forming member and a plurality of movement mechanisms that moves the suction pads in the radial direction of the annular frame. The plurality of suction pads is provided side by side in the circumferential direction of the annular frame, and adjacent ones of the suction pads in the circumferential direction are moved in the radial direction by different ones of the movement mechanisms.

[2] In the conveyance device according to [1], the sucker includes a lock mechanism that fixes the positions of the suction pads in the radial direction and unfixes the suction pads.

[3] In the conveyance device according to [1] or [2], the plurality of suction pads includes a plurality of first suction pads and a second suction pad having weaker suction force of sucking the tire forming member than that of the first suction pads.

[4] In the conveyance device according to any one of [1] to [3], the plurality of suction pads includes a plurality of third suction pads and a plurality of fourth suction pads that releases the tire forming member in advance of the third suction pads.

[5] In the conveyance device according to any one of [1] to [4], the suction pads include a plurality of center suction pads provided side by side in the circumferential direction to suck a center portion of the tire forming member in an axial direction and a plurality of end suction pads provided side by side in the circumferential direction to suck end portions of the tire forming member in the axial direction, and
the sucker includes a gap provided along the axial direction between the center suction pads and the end suction pads and an adjustment device that adjusts the length of the gap in the axial direction.

[6] In the conveyance device according to [5], the adjustment device moves the end suction pads in the axial direction to adjust the length of the gap in the axial direction.

[7] In the conveyance device according to [6], the end suction pads include a first end suction pad provided at one end portion of the tire forming member in the axial direction and a second end suction pad provided at the other end portion of the tire forming member in the axial direction, and
the adjustment device moves the first end suction pad and the second end suction pad in opposite directions in the axial direction in synchronization with each other to adjust the length of the gap in the axial direction.

With the above-described features of the present invention, the simple management of the replacement component is allowed while the increase in the number of set-up change steps due to the tire size change is suppressed.

### BRIEF DESCRIPTION OF THE DRAWINGS

FIG. 1 is a plan view schematically showing a tire molding apparatus using a conveyance device of one embodiment of the present invention;

FIG. 2 is a sectional view of a first drum of the present embodiment taken along the axial direction thereof, which shows the way to bond a tire forming member to the first drum;

FIG. 3 is a view of the conveyance device of one embodiment of the present invention from the axial direction of the tire forming member;

FIG. 4 is a sectional view taken along A-A line in FIG. 3;

FIG. 5 is a view of suction pads and movement mechanisms from the axial direction of the conveyance device;

FIG. 6 is a block diagram showing a control configuration of the conveyance device; and

FIG. 7 is a flowchart showing control of the conveyance device of FIG. 3.

### DESCRIPTION OF EMBODIMENTS

An embodiment will be described with reference to the drawings. Note that the embodiment described below is merely one example and changes made appropriately without departing from the gist of the present invention are included in the scope of the present invention.

### 1. Overall Configuration of Tire Molding Apparatus

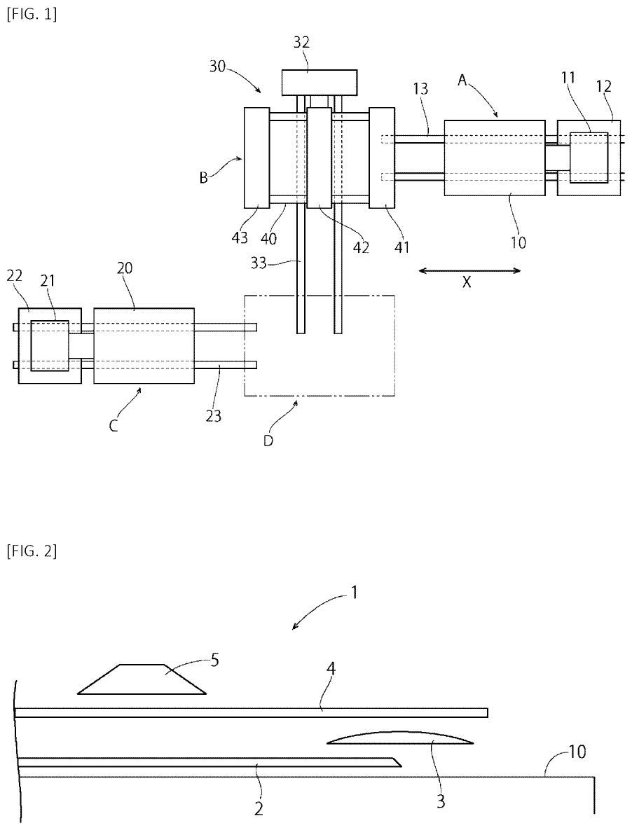

The layout of a tire molding apparatus is shown in FIG. 1. This tire molding apparatus includes a first drum 10, a second drum 20, and a conveyance device 30 that receives a tire forming member molded on the outer peripheral surface of the first drum 10 and conveying the tire forming member to the second drum 20.

The first drum 10 is a drum having a known structure in which a plurality of segments is arranged circumferentially and is in a cylindrical shape as a whole. The plurality of segments moves all at once in a drum radial direction, and the outer peripheral surface of the first drum 10 is increased and decreased in diameter.

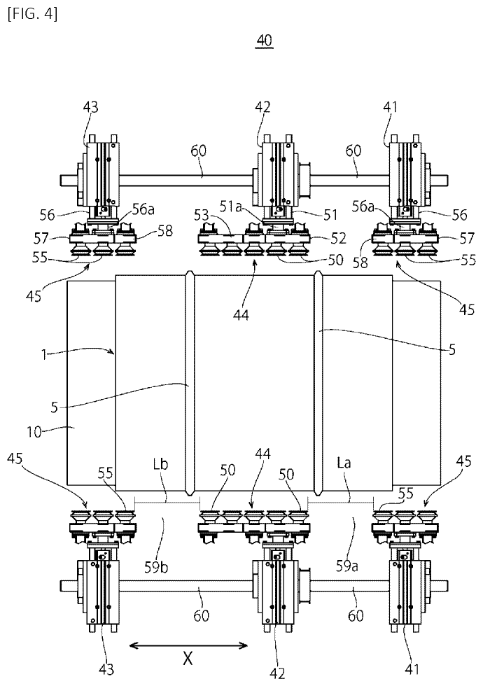

A rubber member is bonded to the outer peripheral surface of the first drum 10, and in this manner, a tire forming member 1 is molded. As one example, a case where a cylindrical carcass band is molded as the tire forming member 1 will be described here. As shown in FIG. 2, an inner liner 2 is first bonded to a center portion of the first drum 10 in the axial direction X thereof. Thereafter, a rubber chafer 3 is bonded to each side of the first drum 10 in the axial direction X thereof so as to overlap with part of the inner liner 2. Thereafter, a carcass ply 4 is bonded to the center portion in the drum axial direction X so as to overlap with the inner liner 2 and the rubber chafers 3. Next, an under-belt pad 5 is bonded to each end portion of the first drum 10 in the axial direction thereof at a position apart from the center of the first drum 10 in the axial direction X thereof by a predetermined distance such that the under-belt pad 5 is located at a position at which a belt end portion is to be disposed in a subsequent step. In the above-described manner, the carcass band (tire forming member) 1 including the inner liner 2, the rubber chafers 3, the carcass ply 4, and the under-belt pads 5 is completed. The tire forming member 1 has a greater rubber thickness at a portion at which the under-belt pad 5 is provided than at other portions, and is in such a shape that an outward bulge in the radial direction of the first drum 10 is continuously formed in the circumferential direction of the first drum 10 (see FIG. 4).

As shown in FIG. 1, the first drum 10 is supported at a rotary shaft thereof by a mount 11. The mount 11 is mounted on a first drum conveyer 12 movable along a later-described rail.

The second drum 20 is a drum to which the tire forming member 1 molded on the first drum 10 is conveyed. For example, the second drum 20 is a drum that receives a cylindrical belt band molded on a not-shown drum in addition to the tire forming member 1 and molds these bands into a tire shape.

The second drum 20 is supported at a rotary shaft thereof by a mount 21. The mount 21 is mounted on a second drum conveyer 22 movable along a later-described rail.

The conveyance device 30 includes a hollow 31 into which the first drum 10 or the second drum 20 is to be inserted. The conveyance device 30 receives the cylindrical tire forming member 1 from the first drum 10 inserted into the hollow 31. Then, when the second drum 20 is inserted into the hollow 31 after the first drum 10 has been removed from the hollow 31, the conveyance device 30 transfers the tire forming member 1 received from the first drum 10 onto the outer peripheral surface of the second drum 20. Note that a specific configuration of the conveyance device 30 will be described later in detail.

A first rail 13, a second rail 23, and a third rail 33 are provided as rails on which the first drum 10, the second drum 20, and the conveyance device 30 move. The first rail 13 and the second rail 23 are linear rails, and are parallel to each other. The third rail 33 is a linear rail, and is perpendicular to the direction of extension of the first rail 13 and the second rail 23.

The first drum conveyer 12 moves on the first rail 13, and the first drum 10 moves between a standby position (indicated by A in FIG. 1) and an intersection (indicated by B in FIG. 1) with the third rail 33 accordingly.

The second drum conveyer 22 moves on the second rail 23, and the second drum 20 moves between a standby position (indicated by C in FIG. 1) and an intersection (indicated by D in FIG. 1) with the third rail 33 accordingly.

A later-described frame conveyer 32 moves on the third rail 33, and the conveyance device 30 moves between the intersection B and the intersection D accordingly. The conveyance device 30 receives the tire forming member 1 from the first drum 10 at the intersection B, and thereafter, moves to the intersection D and transfers the tire forming member 1 to the second drum 20 at the intersection D.

Note that the first drum 10, the second drum 20, and the conveyance device 30 are arranged such that the axial directions X thereof are in the same direction. These axial directions X of the drums 10, 20 and the conveyance device 30 are parallel to the direction of extension of the first rail 13 and the second rail 23.

### 2. Conveyance Device 30

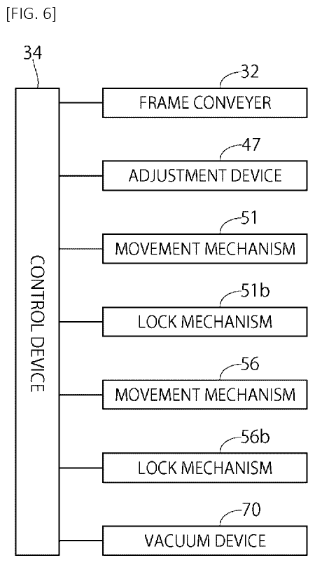

As shown in FIGS. 1 and 6, the conveyance device 30 includes a holding device 40 that holds the outer peripheral surface of the tire forming member 1, the frame conveyer 32 that moves the holding device 40 along the third rail 33, and a control device 34 that controls the holding device 40 and the frame conveyer 32.

As shown in FIGS. 1, 3, and 4, the holding device 40 includes a plurality of annular frames 41, 42, 43 (three in the present embodiment), suckers 44, 45, 45 provided for the annular frames 41, 42, 43, and an adjustment device 47 that moves the annular frames 41, 43 in the axial direction X.

The plurality of annular frames 41, 42, 43 is ring-shaped members having hollows capable of surrounding the outer peripheries of the first drum 10 and the second drum 20. The plurality of annular frames 41, 42, 43 is concentrically arranged at intervals in the axial direction X, and forms the hollow 31 of the conveyance device 30.

The annular frames 41, 43 are end annular frames arranged at both end portions in the axial direction. The annular frame 42 is a center annular frame disposed between the end annular frames 41, 43.

The center annular frame 42 is provided with the suckers 44. The suckers 44 include a plurality of suction pads 50 that sucks the outer peripheral surface of the tire forming member 1 and a plurality of movement mechanisms 51 that moves the plurality of suction pads 50 in the radial direction of the center annular frame 42.

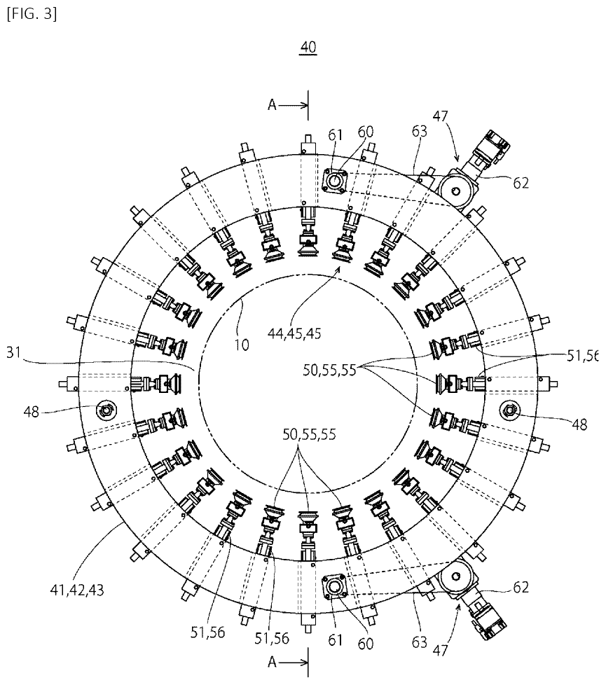

Specifically, the plurality of suction pads 50 is center suction pads that suck a center portion of the tire forming member 1 in the axial direction. The center suction pads 50 are arranged at intervals in the circumferential direction of the center annular frame 42 as shown in FIG. 3, and are arranged side by side at intervals in the axial direction X as shown in FIG. 4.

Ones of the plurality of center suction pads 50 provided side by side in the axial direction X are supported by a support 52 connected to the same movement mechanism 51. On the other hand, the center suction pads 50 adjacent to each other in the circumferential direction of the center annular frame 42 are supported by the supports 52 connected to the different movement mechanisms 51.

That is, ones of the plurality of suction pads 50 provided side by side in the axial direction X move in synchronization with each other in the radial direction of the center annular frame 42 by operation of the same movement mechanism 51. On the other hand, the center suction pads 50 provided at the different positions in the circumferential direction are separately movable in the radial direction of the center annular frame 42 by the different movement mechanisms 51.

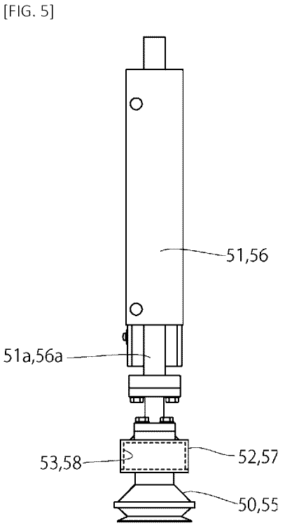

As shown in FIGS. 4 and 5, a vacuum chamber 53 is formed inside the support 52. The vacuum chamber 53 is connected to internal spaces of the center suction pads 50, and is connected to a vacuum device 70 (see FIG. 6). When the vacuum chamber 53 is decreased in pressure by operation of the vacuum device 70, the internal spaces of the center suction pads 50 are also decreased in pressure, and the center suction pads 50 vacuum-suck the center portion of the outer peripheral surface of the tire forming member 1 in the axial direction.

The movement mechanism 51 includes a cylinder in which a rod 51a moves in the radial direction of the center annular frame 42. The movement mechanism 51 moves the rod 51a to an arbitrary position in the movable area of the rod 51a in response to an instruction from the control device 34. The movement mechanism 51 is further provided with a lock mechanism 51b that fixes the rod 51a such that the position thereof does not change (see FIG. 6).

The support 52 is fixed to the rod 51a of the movement mechanism 51 described above. The movement mechanism 51 moves the rod 51a in the radial direction of the center annular frame 42, and accordingly, the center suction pads 50 move between a position (separate position) apart radially outward from the tire forming member 1 provided on the outer peripheral surface of the first drum 10 and a position (contact position) contacting the tire forming member 1.

The end annular frames 41, 43 are provided with the suckers 45, 45 that hold the outer peripheral surface of the tire forming member 1. The sucker 45 provided for the end annular frame 41 sucks one end portion of the tire forming member 1 in the axial direction. The sucker 45 provided for the end annular frame 43 sucks the other end portion of the tire forming member 1 in the axial direction. Note that the sucker 45 provided for the end annular frame 43 is different from the sucker 45 provided for the end annular frame 41 in a position at which the sucker 45 sucks the tire forming member 1, but these suckers have a common structure. The sucker 45 provided for one end annular frame 41 will be described here, and the same reference numerals as those of the components of the sucker 45 for the end annular frame 41 are used to represent corresponding components of the sucker 45 provided for the other end annular frame 43 and description thereof will be omitted.

As shown in FIGS. 3 to 5, the sucker 45 has a configuration similar to that of the sucker 44 provided for the center annular frame 42. The sucker 45 includes a plurality of suction pads 55 that sucks the outer peripheral surface of the tire forming member 1 and a plurality of movement mechanisms 56 that moves the plurality of suction pads 55 in the radial direction of the annular frame.

The plurality of suction pads 55 provided for the end annular frame 41 is end suction pads that contact and suck one end portion of the tire forming member 1 in the axial direction. The end suction pads 55 are arranged at intervals in the circumferential direction of the annular frame 41 as shown in FIG. 3, and are arranged side by side at intervals in the axial direction X as shown in FIG. 4.

Ones of the plurality of end suction pads 55 provided side by side in the axial direction X are supported by a support 57 connected to the movement mechanism 56. Note that the number of end suction pads 55 provided side by side in the axial direction X is preferably less than the number of center suction pads 50 provided side by side in the axial direction X. The end suction pads 55 adjacent to each other in the circumferential direction of the end annular frame 41 are supported by the supports 57 connected to the different movement mechanisms 56.

That is, ones of the plurality of end suction pads 55 provided side by side in the axial direction X move in synchronization with each other in the radial direction of the end annular frame 41 by operation of the same movement mechanism 56. On the other hand, the end suction pads 55 provided at the different positions in the circumferential direction are separately movable in the radial direction of the end annular frame 41 by the different movement mechanisms 56.

A vacuum chamber 58 is formed inside the support 57. The vacuum chamber 58 is connected to internal spaces of the end suction pads 55, and is connected to the vacuum device 70. When the vacuum chamber 58 is decreased in pressure by operation of the vacuum device 70, the internal spaces of the end suction pads 55 are also decreased in pressure, and the end suction pads 55 vacuum-suck the end portion of the outer peripheral surface of the tire forming member 1 in the axial direction.

The movement mechanism 56 includes a cylinder in which a rod 56a moves in the radial direction of the end annular frame 43. The movement mechanism 56 moves the rod 56a to an arbitrary position in the movable area of the rod 56a in response to an instruction from the control device 34. The movement mechanism 56 is further provided with a lock mechanism 56b that fixes the rod 56a such that the position thereof does not change (see FIG. 6).

The support 57 is fixed to the rod 56a of the movement mechanism 56 described above. The movement mechanism 56 moves the rod 56a in the radial direction of the annular frame 43, and accordingly, the end suction pads 55 move between a separate position apart radially outward from the tire forming member 1 provided on the outer peripheral surface of the first drum 10 and a contact position contacting the tire forming member 1.

Note that in the present embodiment, when the holding device 40 is viewed in the axial direction X as shown in FIG. 3, the center suction pads 50 provided for the annular frame 42 and the end suction pads 55 provided for the end annular frames 41, 43 are arranged at the center annular frame 42 and the end annular frames 41, 43 so as to overlap with each other.

The end annular frames 41, 43 provided with the suckers 45 as described above are coupled to a guide shaft 48 fixed to the center annular frame 42 via not-shown bearings. With this configuration, the end annular frames 41, 43 are movable toward and apart from the center annular frame 42 in the axial direction X. As shown in FIG. 4, in a state of the end annular frames 41, 43 being coupled to the center annular frame 42, a gap 59a extending parallel to the axial direction X is formed between the center suction pad 50 provided for the center annular frame 42 and the end suction pad 55 provided for the end annular frame 41. Moreover, a gap 59b extending parallel to the axial direction X is formed between the center suction pad 50 provided for the center annular frame 42 and the end suction pad 55 provided for the end annular frame 43.

As shown in FIG. 3, the adjustment device 47 provided for the end annular frames 41, 43 includes a screw shaft 60 disposed parallel to the guide shaft 48, an attachment bracket 61 having a screw hole into which the screw shaft 60 is to be screwed, and a driver 62 that rotates the screw shaft 60 about an axis. The driver 62 of the adjustment device 47 rotates the screw shaft 60 about the axis via a drive belt 63, thereby slidably moving, together with the attachment bracket 61, the end annular frames 41, 43 fixed to the attachment bracket 61 in the axial direction X. Accordingly, the lengths La, Lb of the gap 59a and the gap 59b in the axial direction X are changed.

In the present embodiment, the adjustment device 47 moves one end annular frame 41 and the other end annular frame 43 in opposite directions in the axial direction X in synchronization with each other. That is, the adjustment device 47 moves one end annular frame 41 and the other end annular frame 43 toward or apart from the center annular frame 42 by the same distance, and moves the end annular frames 41, 43 such that the length La of the gap 59a and the length Lb of the gap 59b are equal to each other.

The control device 34 mainly includes a microcomputer, and controls operation of the conveyance device 30 as a whole. The control device 34 controls the frame conveyer 32, the adjustment device 47, the movement mechanisms 51, 56, 56, the lock mechanisms 51b, 56b, 56b thereof, and the vacuum device 70 that decreases the pressures in the vacuum chambers 53, 58, 58.

### 3. Operation of Conveyance Device 30

Next, operation when the conveyance device 30 receives the cylindrical tire forming member 1 formed on the first drum 10 and conveys the tire forming member 1 to the second drum 20 will be described.

First, the conveyance device 30 sets areas where the movement mechanisms 51, 56, 56 of the suckers 44, 45, 45 move the rods 51a, 56a, 56a according to the size of the tire forming member 1 molded on the outer peripheral surface of the first drum 10. That is, the conveyance device 30 sets the areas where the rods 51a, 56a, 56a of the movement mechanisms 51, 56, 56 move such that the suction pads 50, 55, 55 move between the separate position apart radially outward from the tire forming member 1 and the contact position contacting the tire forming member 1.

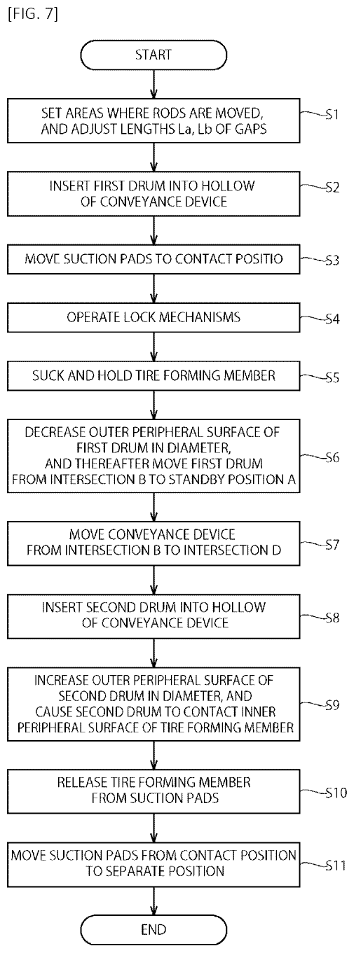

Moreover, the adjustment device 47 changes the positions of the end annular frames 41, 43 in the axial direction X with respect to the center annular frame 42 to adjust the lengths La, Lb of the gaps 59a, 59b such that when the first drum 10 moves into the hollow 31 of the conveyance device 30, the under-belt pads 5 provided for the tire forming member 1 are located in the gaps 59a, 59b formed between the center suction pad 50 and the end suction pads 55, 55 in the axial direction X (Step S1 of FIG. 7).

Note that the setting of the areas where the movement mechanisms 51, 56, 56 move the rods 51a, 56a, 56a and the adjustment of the lengths La, Lb of the gaps 59a, 59b are performed when the size or type of a tire to be manufactured is changed, and are not necessarily performed in every conveyance of the tire forming member 1.

Then, in a state of the conveyance device 30 being located at the intersection B and the suction pads 50, 55, 55 being located at the separate position, the first drum 10 having the tire forming member 1 on the outer peripheral surface is moved to the intersection B, and is inserted into the hollow 31 of the conveyance device 30 (Step S2 of FIG. 7). In the present embodiment, the first drum 10 is inserted into the hollow of the conveyance device 30 such that the center portion of the tire forming member 1 in the axial direction X is coincident with a center portion of the sucker 44, which is provided for the center annular frame 42, in the axial direction X (see FIG. 4).

As described above, the conveyance device 30 sets the separate positions and contact positions of the suction pads 50, 55, 55 and the gaps 59a, 59b formed between the center suction pad 50 and the end suction pads 55, 55 according to the size of the tire forming member 1. Thus, when the first drum 10 is inserted into the hollow 31 of the conveyance device 30, the suction pads 50, 55, 55 of the suckers 44, 45, 45 face the outside of the tire forming member 1, which is provided on the outer peripheral surface of the first drum 10, in the radial direction thereof with a clearance therebetween. Moreover, the under-belt pads 5 provided for the tire forming member 1 are arranged at the positions of the gaps 59a, 59b of the conveyance device 30 in the axial direction X.

Thereafter, the movement mechanisms 51, 56, 56 move the suction pads 50, 55, 55 from the separate position to the contact position, and cause the suction pads 50, 55, 55 to contact the tire forming member 1 (Step S3 of FIG. 7). Since the under-belt pads 5 provided for the tire forming member 1 are arranged at the positions of the gaps 59a, 59b of the conveyance device 30, the center suction pads 50 contact the tire forming member 1 inside the under-belt pads 5 (center side in the axial direction X with respect to the under-belt pads 5), and the end suction pads 55, 55 contact the tire forming member 1 outside the under-belt pads 5 (end sides in the axial direction X with respect to the under-belt pads 5). That is, the center suction pads 50 and the end suction pads 55, 55 contact the tire forming member 1 with avoiding the under-belt pads 5.

Then, when the suction pads 50, 55, 55 move to the contact position and contact the tire forming member 1, the lock mechanisms of the movement mechanisms 51, 56, 56 are operated to fix the positions of the rods 51a, 56a, 56a of the movement mechanisms 51, 56, 56 to prevent the positions of the center suction pads 50 and the end suction pads 55, 55 from changing (Step S4 of FIG. 7).

Then, the vacuum chambers 53, 58, 58 provided in the supports 52, 57, 57 are decreased in pressure by the vacuum device 70, and accordingly, the center suction pads 50 and the end suction pads 55, 55 suck and hold the tire forming member 1 (Step S5 of FIG. 7).

Then, the outer peripheral surface of the first drum 10 is decreased in diameter, and thereafter, the first drum 10 is moved from the intersection B to the standby position A and the tire forming member 1 is transferred from the first drum 10 to the conveyance device 30 (Step S6 of FIG. 7).

Then, in a state of the second drum 20 being disposed at the standby position C, the conveyance device 30 is moved from the intersection B to the intersection D (Step S7 of FIG. 7).

Then, the second drum 20 is moved from the standby position C to the intersection D, and is inserted into the hollow 31 of the conveyance device 30 (Step S8 of FIG. 7). Note that upon the movement from the standby position C to the intersection D, the outer peripheral surface of the second drum 20 is decreased in diameter to the diameter smaller than the inner diameter of the tire forming member 1.

Then, the outer peripheral surface of the second drum 20 is increased in diameter to contact the inner peripheral surface of the tire forming member 1, and accordingly, the second drum 20 holds the tire forming member 1 (Step S9 of FIG. 7).

Then, the decrease in the pressures in the vacuum chambers 53, 58, 58 by the vacuum device 70 is stopped, and the tire forming member 1 is released from the center suction pads 50 and the end suction pads 55, 55 (Step S10 of FIG. 7).

Then, the movement mechanisms 51, 56, 56 move the suction pads 50, 55, 55 from the contact position to the separate position, and transfers the tire forming member 1 to the second drum 20 (Step S11 of FIG. 7).

### 4. Effects

In the present embodiment, the suction pads 50, 55, 55 provided at the different positions in the circumferential direction are separately movable in the radial direction by the different movement mechanisms 51. Even in the case of different sizes of the tire forming member, the areas where the suction pads 50, 55, 55 move are changed so that the tire forming member can be sucked and released. Thus, even in a case where tires with different sizes are manufactured, an increase in the number of set-up change steps can be suppressed and management of a replacement component can be simplified.

Compressive force may act on the tire forming member 1 when the suction pads 50, 55, 55 move from the separate position to the contact position, and tensile force may act on the tire forming member 1 when the suction pads 50, 55, 55 move from the contact position to the separate position. In the present embodiment, since the suction pads 50, 55, 55 provided at the different positions in the circumferential direction are separately moved in the radial direction by the different movement mechanisms 51, 56, the above-described compressive force and tensile force easily uniformly act in the radial direction, and therefore, local deformation of the tire forming member 1 can be reduced.

The movement mechanisms 51, 56, 56 that move the suction pads 50, 55, 55 include the lock mechanisms 51b, 56b, 56b that limit movement of the suction pads 50, 55, 55. Thus, undesirable deformation of the tire forming member 1 due to movement of the suction pads 50, 55, 55 while the suction pads 50, 55, 55 are holding the tire forming member can be prevented.

In the present embodiment, the lengths La, Lb of the gaps 59a, 59b, which are formed between the center suction pad 50 and the end suction pads 55, 55, in the axial direction X can be adjusted. Thus, even in a case where the outward bulge in the radial direction is continuously formed in the circumferential direction on the tire forming member, the suction pads 50, 55, 55 can suck the tire forming member at the positions avoiding such a bulge. Consequently, the suction force of the suction pads 50, 55, 55 is less likely to locally act on the tire forming member, and as a result, degradation of the uniformity of a molded tire due to entering of air into the tire forming member 1 or non-uniform arrangement of a reinforcing member such as a carcass cord can be prevented.

In the present embodiment, the adjustment device 47 moves one end annular frame 41 and the other end annular frame 43 in the opposite directions in the axial direction X in synchronization with each other, thereby adjusting the lengths La, Lb of the gaps 59a, 59b in the axial direction X. Thus, the adjustment device 47 allows both the end annular frames 41, 43 to move by a common drive source, leading to a simple configuration of the adjustment device 47.

### 5. Modifications

Modifications of the above-described embodiment will be described. Any one of the plurality of modifications described below may be applied to the above-described embodiment, or any two or more of the modifications described below may be applied in combination to the above-described embodiment. Note that various changes can also be made in addition to the following modifications.

### (1) Modification 1

When the tire forming member 1 is sucked and held by the plurality of suction pads 50, 55, 55, the suction force of the plurality of suction pads 50, 55, 55 for sucking the tire forming member 1 may be set equally for all the suction pads 50, 55, 55. However, the plurality of suction pads 50, 55, 55 may be divided into a first suction pad group with strong suction force and a second suction pad group with weaker suction force than that of the first suction pad group, and the suction force may be differentiated according to the positions at which the suction pads 50, 55, 55 suck the tire forming member 1.

For example, in a case where the axial direction X of the conveyance device 30 is in the horizontal direction, ones of the plurality of center suction pads 50 and end suction pads 55, 55 that suck the upper side of the tubular tire forming member 1 with respect to the center axis thereof are set as the first suction pad group. Ones of the plurality of center suction pads 50 and end suction pads 55, 55 that suck the lower side of the tire forming member 1 with respect to the center axis thereof are set as the second suction pad group. The suction force of the plurality of suction pads 50, 55, 55 set as the second suction pad group is set less than the suction force of the plurality of suction pads 50, 55, 55 set as the first suction pad group.

The first suction pad group and the second suction pad group are set as described above so that the force acting on the tire forming member 1 can be uniform in the circumferential direction in consideration of the force of gravity acting on the tire forming member 1. A situation of the tire forming member 1 being not held due to insufficient suction force for the tire forming member 1 on the upper side of the tire forming member 1 or a situation of the tire forming member 1 being undesirably deformed due to excessive suction force for the tire forming member 1 on the lower side of the tire forming member 1 can be prevented.

### (2) Modification 2

When the movement mechanisms 51, 56, 56 move the suction pads 50, 55, 55 from the contact position to the separate position to transfer the tire forming member 1 to the second drum 20, the suction pads 50, 55, 55 may release the tire forming member 1 all at once, and thereafter, all the suction pads 50, 55, 55 may be simultaneously moved to the separate position. Alternatively, the plurality of suction pads 50, 55, 55 may be divided into a fourth suction pad group to be first moved from the contact position to the separate position and a third suction pad group to be moved to the separate position after the suction pads in the fourth suction pad group have been moved, and the timing of moving the suction pads 50, 55, 55 from the contact position to the separate position may be differentiated according to the positions at which the suction pads 50, 55, 55 suck the tire forming member 1.

For example, all the suction pads 50, 55, 55 are divided into the third suction pad group and the fourth suction pad group such that adjacent ones of the suction pads 50, 55, 55 in the circumferential direction are in different suction pad groups.

Then, after Steps S1 to S9 in the above-described embodiment have been sequentially executed (i.e., after the outer peripheral surface of the second drum 20 has contacted the inner peripheral surface of the tire forming member 1 and the second drum 20 has held the tire forming member 1), the suction pads 50, 55, 55 in the fourth suction pad group release the tire forming member 1 while the suction pads 50, 55, 55 in the third suction pad group keep sucking and holding the tire forming member 1, and thereafter, the suction pads 50, 55, 55 in the fourth suction pad group are moved to the separate position.

Thereafter, the suction pads 50, 55, 55 in the third suction pad group release the tire forming member 1, and thereafter, are moved to the separate position.

Adjacent ones of the suction pads 50, 55, 55 in the circumferential direction are moved to the separate position at the different timings as in the present modification, so that the suction pads 50, 55, 55 are easily detached from the tire forming member 1. Thus, the tire forming member 1 is prevented from being undesirably deformed when the suction pads 50, 55, 55 are moved to the separate position.

### (3) Modification 3

In the above-described embodiment, a pressure sensor that measures the pressures of the vacuum chambers 53, 58, 58 may be provided, and based on the pressures detected by the pressure sensor, it may be determined whether the tire forming member 1 has been normally sucked and held by the suction pads 50, 55, 55, or it may be determined whether the suction pads 50, 55, 55 has normally released the tire forming member 1.

For example, after Steps S1 to S5 in the above-described embodiment have been sequentially executed (i.e., after the vacuum chambers 53, 58, 58 have been decreased in pressure by the vacuum device 70), the pressures of the vacuum chambers 53, 58, 58 after a lapse of predetermined time (e.g., after a lapse of three seconds) since the decrease in the pressures of the vacuum chambers 53, 58, 58 was started are measured by the pressure sensor. In a case where the measured pressures reach a predetermined value or less, it is determined that the tire forming member 1 is normally sucked and held by the suction pads 50, 55, 55, and the process proceeds to next Step S6.

On the other hand, in a case where the measured pressures do not reach the predetermined value or less, it is determined that the tire forming member 1 is not normally sucked and held by the suction pads 50, 55, 55, and the process does not proceed to next Step S6 and an notification of an abnormality is made.

After the steps up to Step S11 in the above-described embodiment have been sequentially executed (after the suction pads 50, 55, 55 have been moved to the separate position), the pressures of the vacuum chambers 53, 58, 58 after a lapse of predetermined time (e.g., after a lapse of three seconds) since the suction pads 50, 55, 55 were moved to the separate position are measured by the pressure sensor. In a case where the measured pressures are a predetermined value or more, it is determined that the tire forming member 1 has been normally released from the suction pads 50, 55, 55 and transferred to the second drum 20, the transfer of the tire forming member 1 to the second drum 20 is completed.

On the other hand, in a case where the measured pressures do not reach the predetermined value or more, it is determined that the tire forming member 1 has not been normally released from the suction pads 50, 55, 55 and transferred to the second drum 20, and a notification of an abnormality is made.

In this modification, a state of the tire forming member 1 having been normally sucked and held by the suction pads 50, 55, 55 and a state of the sucked and held tire forming member 1 having been normally released can be detected with a simple configuration.

### REFERENCE SIGNS LIST

10: First Drum
11: Mount
12: First Drum Conveyer
13: First Rail
20: Second Drum
21: Mount
22: Second Drum Conveyer
23: Second Rail
30: Conveyance Device
31: Hollow
32: Frame Conveyer
33: Third Rail
34: Control Device
40: Holding Device
41: End Annular Frame
42: Center Annular Frame
43: End Annular Frame
44: Sucker
45: Sucker
47: Adjustment Device
48: Guide Shaft
50: Center Suction Pad
51: Movement Mechanism
51a: Rod
51b: Lock Mechanism
52: Support
53: Vacuum Chamber
55: Suction Pad
56: Movement Mechanism
56a: Rod
56b: Lock Mechanism
57: Support
58: Vacuum Chamber
60: Screw Shaft
61: Attachment Bracket
62: Driver
63: Drive Belt
70: Vacuum Device

What is claimed is:

1. A conveyance device for receiving a cylindrical tire forming member formed on a first drum from the first drum and conveying the tire forming member to a second drum, comprising:
an annular frame capable of surrounding outer peripheries of the first drum and the second drum;
a sucker provided for the annular frame; and
a frame conveyer that conveys the annular frame between the first drum and the second drum,
wherein the sucker includes a plurality of suction pads that sucks the tire forming member and a plurality of movement mechanisms that moves the suction pads in a radial direction of the annular frame, and
the plurality of suction pads is provided side by side in a circumferential direction of the annular frame, and adjacent ones of the suction pads in the circumferential direction are moved in the radial direction by different ones of the movement mechanisms.

2. The conveyance device according to claim 1, wherein the sucker includes a lock mechanism that fixes positions of the suction pads in the radial direction and unfixes the suction pads.

3. The conveyance device according to claim 1, wherein the plurality of suction pads includes a first suction pad and a second suction pad having weaker suction force of sucking the tire forming member than that of the first suction pad.

4. The conveyance device according to claim 1, wherein the plurality of suction pads includes a plurality of third suction pads and a plurality of fourth suction pads that releases the tire forming member in advance of the third suction pads.

5. The conveyance device according to claim 1, wherein the suction pads include a plurality of center suction pads provided side by side in the circumferential direction to suck a center portion of the tire forming member in an axial direction and a plurality of end suction pads provided side by side in the circumferential direction to suck end portions of the tire forming member in the axial direction, and
the sucker includes a gap provided along the axial direction between the center suction pads and the end suction pads and an adjustment device that adjusts a length of the gap in the axial direction.

6. The conveyance device according to claim 5, wherein the adjustment device moves the end suction pads in the axial direction to adjust the length of the gap in the axial direction.

7. The conveyance device according to claim 6, wherein the end suction pads include a first end suction pad provided at one end portion of the tire forming member in the axial direction and a second end suction pad provided at the other end portion of the tire forming member in the axial direction, and
the adjustment device moves the first end suction pad and the second end suction pad in opposite directions in the axial direction in synchronization with each other to adjust the length of the gap in the axial direction.
